(19) United States
(12) Patent Application Publication
(10) Pub. No.: US 2007/0147220 A1
(43) Pub. Date: Jun. 28, 2007

(54) Multiple-spiral hybrid disc for e-book applications

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,187

(22) PCT Filed: Feb. 21, 2005
(86) PCT No.: PCT/IB05/50625

§ 371 Date: Aug. 21, 2006

(30) Foreign Application Priority Data
Feb. 26, 2004 (EP) 04100763.4

(51) Int. Cl. G11B 7/24

(52) U.S. Cl. 369/275.4; 369/275.3

(57) ABSTRACT

The invention relates to an optical disc (10) comprising a hybrid information layer with at least two congruently adjoining spirals, whereby a first spiral (12) of said adjoining spirals comprises a ROM section containing read only data and a second spiral (14) of said adjoining spirals comprises a recordable section having a pre-groove provided for tracking purposes during recording. Said ROM section and said recordable section are arranged at least partially adjoining each other thereby forming an overlap region where a track of said first spiral containing read only data is arranged next to an associated track of said second spiral containing a pre-groove.

Optical record carriers such as optical discs have seen an evolutionary increase in data capacity by increasing the numerical aperture of the objective lens and a reduction of the laser wavelength. The total data capacity increased from 650 MB (CD, NA=0.45, (λ=780 nm) to 4.7 GB (DVD, NA=0.65, λ=670 nm) to presently 25 GB (Blu-ray disk (BD), NA=0.85, λ=405 nm). Read only BD (BD-ROM), write once BD as well as rewritable BD standards are going to be established. Possible applications for such high-data capacity discs are, for example, HDTV video recording, archiving, data back-up and an E-books.

While the former applications typically demand for recordable (write once or re-writable) discs the latter application (E-book) requires a record carrier simultaneously providing ROM functionality and recording functionality. For example, when a person purchases an E-book BD disc with the content of a textbook and he starts reading he may want to make notes, for example in between the text lines, or highlight some important text. He may also have to do exercises, answer questions or the like in a workbook being additional content of the same e-book BD disc. These notes, marks and written text, also referred to as add-on information, can be stored on such a BD disc which besides ROM functionality also provides recording functionality.

Generally, an optical disc having ROM and recording functionality at a time, hereinafter also referred to as hybrid optical disc, is an adequate solution to combine the advantage of content distribution (e.g. the text book) and storage of add-on information. Such hybrid discs are known from patents of IBM and DataPlay, for example. While DataPlay proposes a disc with sections (segments or partitions) being reserved for writing, IBM has claimed a disc having two different information layers, the first information layer containing ROM data only (pre-recorded information layer), the second information layer being recordable (recordable information layer). Further, in U.S. Pat. No. 6,300,041 B1 an optical recording medium with a single information layer is presented comprising a data recording area, having a double spiral structure with two pre-grooved spirals each dedicated for recording, and a subsequent separate area with a single spiral consisting of a pit row constituting pre-recorded ROM data. An information layer in a disc providing ROM functionality as well as recording functionality hereinafter is also referred to as hybrid information layer.

While these hybrid discs allow for both reproduction of ROM data and recording add-on information they are not specially designed for E-book applications. When add-on information is directly connected to ROM data, e.g. when ROM-text is marked by a reader, both information should be accessible at the same time since the reader instantaneously wants to see the ROM-text and his add-on. Thus, E-book applications require fast access to both data, which is not satisfactorily provided by the above hybrid optical discs.

It is an objective of the present invention to provide a hybrid optical disc which is better adapted to E-book applications and which allows for faster access to both ROM-data and recordable/written partitions.

According to a first aspect of the invention this object is achieved by an optical disc comprising a hybrid information layer with at least two congruently adjoining spirals, whereby a first spiral of said adjoining spirals comprises a ROM section containing read only data and a second spiral of said adjoining spirals comprises a recordable section having a pre-groove provided for tracking purposes during recording, and whereby said ROM section and said recordable section are arranged at least partially adjoining each other thereby forming an overlap region where a track (360° turn of a continuous spiral) of said first spiral containing read only data is arranged next to an associated track of said second spiral containing a pre-groove.

Thus, in the overlap region ROM data stored in the ROM section of the first spiral and related add-on information recorded in the recordable section of the second spiral can be arranged side by side, i.e. at identical positions on the congruently adjoining spirals. By this means the occurrence of large distance jumps of the optical head or the laser spot during writing and/or reading can be minimized. A faster access to both kinds of data is possible due to fact that the recordable/recorded tracks are in the proximity of the ROM tracks. As a further benefit due to the reduced distance the mechanical load of the reading/writing device can be reduced.

According to a second aspect, which constitutes a further development of the first aspect of the invention, said ROM section extends over an entire data zone of said first spiral.

In case of a double spiral hybrid disc the ROM section covers at least 50% of the total data capacity of said disc. By this means every recordable section in the second spiral entirely adjoins pre-recorded ROM data.

According to a third aspect, which constitutes a further development of the first or second aspect of the invention, a recording material is provided covering also said ROM section.

Known rewritable information layers commonly comprise a phase-change material, which typically is an alloy with a durable polycrystalline structure, sandwiched between two dielectric ZnS—SiO2 layers. A metallic layer is commonly added to improve the optical and thermal properties. A writing laser beam modulated by a recording signal will principally be absorbed by the phase-change material, thereby inducing a phase change, typically from its initial crystalline phase into an amorphous phase. Whereas the crystalline phase (ground state) has typically a high reflectivity the amorphous phase (written state) has a reduced reflectivity. Therefore, a reading beam focused on such a rewritable information layer is reflected with different intensity depending on whether it strikes a written mark (pit) or an unwritten area (land).

Known write once information layers typically make use of an organic dye material such as cyanine, phthalocyanine or metallized azo. A reflective metal layer, typically made of gold or silver or aluminum, is deposited adjacent to the dye layer forming a recording stack. A writing laser beam will be partially absorbed by the dye layer, thereby durably and irreversibly bleaching and decomposing the dye material. A reading beam striking a mark written in that manner will be partially scattered by that mark. Consequently, the intensity of the light reflected from the recording stack depends on whether the reading beam strikes a written mark or unwritten part of the recording stack.

Particularly, with regard to actual and future optical data storage related research, the invention is not limited to the above mentioned recording techniques and recording materials. For example, inorganic material systems such as Cu—Si are currently investigated for BD-R discs. In that case, laser induced heating causes mixing of the Cu and Si layer, thereby forming a state with optical properties different than that of the initial state.

In any case, recording induces a change in the optical reflection of the recordable information layer. Although the ROM section in the hybrid information layer of the disc according to the invention contains information in the form of pre-mastered pits, and therefore recording at the location of the ROM section is undesirable, according to the third aspect of the invention the recording material extends over the entire hybrid information layer. The advantage of such an arrangement is that well established manufacturing methods for recordable discs can be applied and the costs of such a disc can be kept low.

In order to avoid overwriting of a ROM section according to a fourth aspect, which constitutes a further development of anyone of the first to third aspects of the invention, control information is provided enabling writing only on said recordable section.

This control information allows writing only on predetermined portions of said disc, namely said recordable sections. The control information may be provided, e.g. in the lead in track, in the recordable section itself by providing a wobbled pre-groove, or in other sections reserved for control information, only.

According to a fifth aspect, which constitutes a further development of anyone of the first to fourth aspects of the invention, the disc further comprises a recordable information layer.

According to a sixth aspect, which constitutes a further development of anyone of the first to fifth aspects of the invention, the disc further comprises a pre-recorded information layer.

The present invention therefore also applies to multiple layer discs having two or more information layers for different purposes.

The above an other objects, features and advantages of the present invention will become apparent from the following description of preferred embodiments thereof taken in conjunction with the accompanying drawings in which

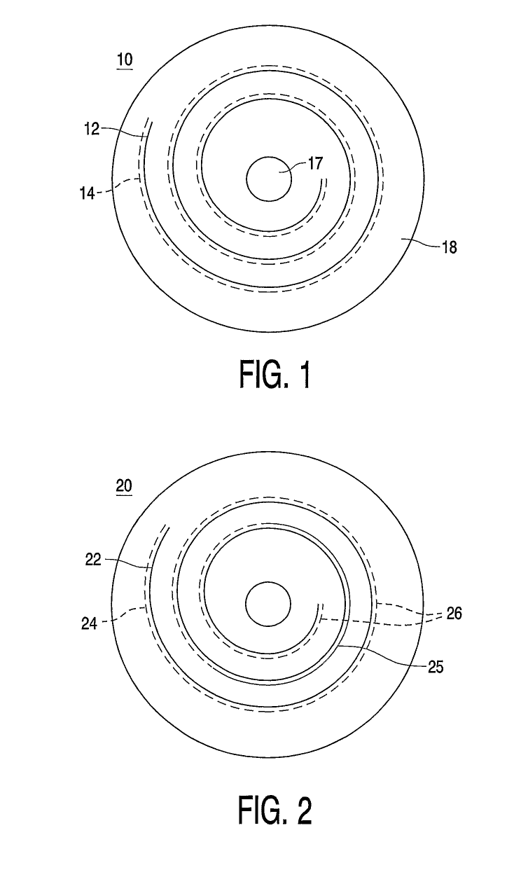

FIG. 1 shows a simplified structure of an optical double-spiral hybrid disc according to a first embodiment of the present invention;

FIG. 2 shows a simplified structure of an optical double-spiral hybrid disc according to a second embodiment of the present invention;

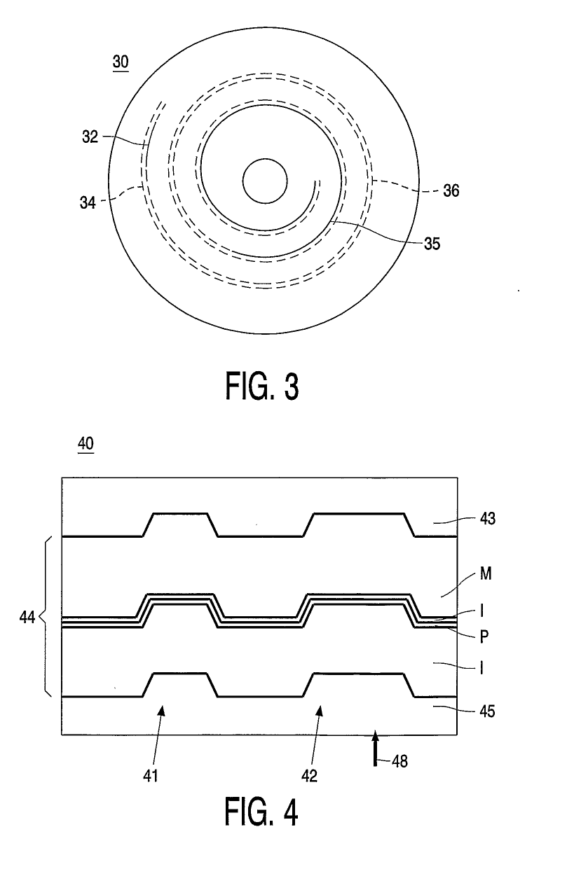

FIG. 3 shows a simplified structure of an optical double-spiral hybrid disc according to a third embodiment of the present invention; and

FIG. 4 shows a cross sectional view of an optical multiple-spiral hybrid disc according to another embodiment of the present invention.

The double spiral disc 10 according FIG. 1 comprises a hybrid structure according to a first embodiment of the invention. This hybrid structure consists of two adjoining congruent spirals 12 and 14. The spirals are shown within the data area of the disc, only. In this data area the first spiral 12 of the two spirals consists solely of ROM data, namely pre-mastered pits of different run length to encode binary data. The second spiral consists solely of a pre-groove for tracking purposes and is provided for recording add-on information. In other words, according to this embodiment the first spiral consists of a single ROM section, the second spiral consists of a single recordable section and the overlap region formed by both sections covers the total data area. Thus, the ratio of ROM data capacity to add-on information capacity in this case is 1:1. Both spirals may be intended for reading/recording in a direction from the inside 17 to the outside 18 of the disc, or vice versa.

The double spiral disc 20 according FIG. 2 again comprises two adjoining congruent spirals 22 and 24, the first spiral 22 of which only contains ROM data. According to this embodiment the second spiral 24 consists alternately of partitions 25 of pre-mastered pits (ROM data) and partitions 26 of pre-grooves. By means of dividing the second spiral into partitions as shown in FIG. 2 the total ROM capacity can be increased to more than 50% of the overall capacity of the disc while the total recordable capacity will be decreased to below 50%. The overlap regions formed according to this embodiment range from the beginning of each recordable partition 26 to its end.

According to the hybrid structure of a third embodiment shown in FIG. 3 it is also possible to reduce the total ROM capacity of the disc 30 to less than 50% by similarly dividing the first spiral 32 into ROM partitions 35 and recordable partitions 36 while the second spiral 34 consists of a single pre-groove partition. The overlap regions in this case range from the beginning of each ROM partition 35 to its end.

Thus, the total ROM capacity can be individually chosen to meet the requirements of the application, for example, of a text book, which are known on forehand. The available recordable capacity is then the difference between the overall data capacity (23.3, 25 or 27 GB for the BD system) and the appointed ROM data. Using a 25 GB BD system, for example, the following data capacity ratios can be provided: In case of a text book 20 GB ROM partitions, 5 GB recordable partition; in case of a work book 12.5 GB ROM partitions, 12.5 GB recordable partitions; and in case of novels, or other storybooks 24 GB ROM partitions, 1 GB recordable partitions.

Further, other than, e.g. in U.S. Pat. No. 6,300,041 where the ROM section and the recordable section are arranged in succession, the arrangement of ROM partitions and recordable partitions in the first and/or second spiral can be chosen to provide the best possible interactive functionality depending on the specific features of the e-book application.

Preferably, the length of recordable partitions consists of 50 or more error correcting code (ECC) blocks to enable the storage of a substantial data set. In case of a BD disc depending on the radial position 2-5 ECC blocks are arranged per revolution. If such a recordable partition on the second spiral totally overlaps with a RAM section on the adjoining first spiral the overlap region spans more than one revolution (between 10 and 25) so that tracks containing ROM data in radial direction repeatedly alternate with recordable tracks (due to simplification not shown in the Figures).

Referring to FIG. 4, a cross sectional view in radial direction showing a part of a single layer rewritable hybrid disc 40 according to the invention is presented. There are two adjacent tracks shown. The first track comprises pre-recorded pits 41, the second track comprises a pre-groove 42 for tracking purposes. As can be seen the disc is composed of a substrate 43 carrying a recording stack 44. As can be seen, this structure is provided all over the disc similarly covering ROM sections and recordable sections . The recording stack 44, also referred to as IPIM-stack, is well-known. It contains a phase-change recording layer P sandwiched between two dielectric layers I, providing for the required temperature distribution over the stack, and adjacent to the substrate a metallic mirror layer M, for adjusting the optical and thermal properties of the disc. On the opposite side of the substrate 43, a cover layer 45 is laminated onto the recording stack 44. For Blu-ray disc (BD-ROM, BD-RE, BD-R) readout is through the cover layer, as indicated by arrow 48. For DVD, the stack is deposited on top of the substrate. The stack is covered with a protection cover. Readout is through the substrate side.

The mastered hybrid disc 40 comprises at least two spirals (not shown) partly comprising pre-grooves 42 and partly being provided with pre-mastered pits 41 according to anyone of the patterns discussed in accordance with FIGS. 1 to 3. Such a patterns can be mastered in a known manner with deep-UV liquid immersion mastering (LIM) or E-beam mastering set-ups.

Whichever pattern is provided, in case of such a rewritable hybrid disc 40 sufficient reflection also in ROM areas can be guaranteed by utilizing an IPIM stack 44 with appropriate layer thicknesses. However, since the recording stack 44 covers the entire disc a software protection, such as control information, has to be incorporated to prevent data storage in the ROM areas.

In case of a write-once hybrid disc, the simpler dye recording technology can be applied. The IPIM-stack in this case will be substituted by a stack composed of a dye layer and a mirror layer.

While the embodiments described above with reference to the figures relate to discs comprising a single information layer only, the present invention may also apply to multiple layer discs having two or more information layers. In particular, any of the above proposed hybrid structures can be applied to a single information layer or to multiple information layers in a multiple layer disc. Further, hybrid information layer(s) with 2 congruent spirals, one for pre-recorded ROM data and one with a combination of pre-recorded ROM and pre-recorded grooves for add-on data, can be applied in a multiple-layer disc, whereby other information layer(s) may contain only pre-recorded data or pre-recorded grooves for re-writable or write-once recording. The data in a first information layer according to anyone of the above embodiments then may be arranged in a way that it is readable and writable from the inside to the outside of the disc while a second information layer may be readable and writable in reverse direction, as known from DVD standards, or vice versa.

Further, this invention is not limited to an optical disc comprising a double spiral hybrid structure but may also apply to 3 or more spirals.

1. Optical disc (10, 20, 30) comprising a hybrid information layer with at least two congruently adjoining spirals, whereby a first spiral (12, 22, 32) of said adjoining spirals comprises a ROM section containing read only data and a second spiral (14, 24, 34) of said adjoining spirals comprises a recordable section having a pre-groove provided for tracking purposes during recording, and whereby said ROM section and said recordable section are arranged at least partially adjoining each other thereby forming an overlap region where a track of said first spiral containing read only data is arranged next to an associated track of said second spiral containing a pre-groove.

2. Optical disc according to claim 1, characterized in that said ROM section extends over an entire data zone of said first spiral.

3. Optical disc according to claim 1, characterized in that a recording layer is provided covering also said ROM section.

4. Optical disc according to claim 3, characterized in that control information is provided enabling writing only on said recordable section.

5. Optical disc according to claim 1, comprising a recordable information layer.

6. Optical disc according to claim 1, comprising a pre-recorded information layer.
